(19) United States
(12) Patent Application Publication
(10) Pub. No.: US 2026/0187706 A1
(43) Pub. Date: Jul. 2, 2026

(54) METHOD, APPARATUS, DEVICE AND STORAGE MEDIUM FOR ORDER PROCESSING

(71) Applicant: DOUYIN VISION CO., LTD., Shijingshan District, Beijing (CN)

(72) Inventor: Bo Wu, Beijing (CN)

(21) Appl. No.: 19/124,227

(22) PCT Filed: Mar. 12, 2024
(86) PCT No.: PCT/CN2024/081243

§ 371 Date: Apr. 24, 2025

(30) Foreign Application Priority Data
Mar. 20, 2023 (CN) 202310274259.4

(51) Int. Cl. G06Q 30/0601; G06Q 10/06

(52) U.S. Cl. CPC G06Q 30/0635; G06Q 10/06

(57) ABSTRACT

According to embodiments of the disclosure, a method, an apparatus, a device and a storage medium for order processing are provided. The method includes: determining a group of orders associated with a target time window, the group of orders being uncompleted; requesting a business party associated with the group of orders to execute the group of orders; in response to receiving a message from the business party indicating that the group of orders are completed, querying an order database maintained by the business party to verify whether the group of orders are completed; an in response to the group of orders being verified as completed, updating a state of the group of orders to indicate that the orders are completed.

This application claims the benefit of Chinese Patent Application No. 202310274259.4, filed on Mar. 20, 2023, entitled “Method, Apparatus, Device and Storage Medium for Order Processing”, the entire content of which is incorporated herein by reference.

### FIELD

Example embodiments of the present disclosure generally relate to the field of computers, and in particular, to a method, an apparatus, a device and a computer-readable storage medium for order processing.

### BACKGROUND

In a payment process, an order may not be effectively completed because of various network or processing abnormalities. Thus, order compensation (i.e., pushing the order execution to the middle platform) has become an important task in order systems.

Traditional order compensation systems detect orders to be processed by polling a database. However, this manner is usually inefficient and leads to situations such as missed orders and stuck orders.

### SUMMARY

In a first aspect of the present disclosure, a method for processing an order is provided. The method includes: determining a group of orders associated with a target time window, the group of orders being uncompleted; requesting a business party associated with the group of orders to execute the group of orders; in response to receiving a message from the business party indicating that the group of orders are completed, querying an order database maintained by the business party to verify whether the group of orders are completed; and in response to the group of orders being verified as completed, updating a state of the group of orders to indicate that the orders are completed.

In a second aspect of the present disclosure, an apparatus for processing an order is provided. The apparatus includes a determining module configured to determine a group of orders associated with a target time window, the group of orders being uncompleted; a requesting module configured to request a business party associated with the group of orders to execute the group of orders; a verifying module configured to, in response to receiving a message from the business party indicating that the group of orders are completed, query an order database maintained by the business party to verify whether the group of orders are completed; and an updating module configured to, in response to the group of orders being verified as completed, update a state of the group of orders to indicate that the orders are completed.

In a third aspect of the present disclosure, an electronic device is provided. The device includes at least one processing unit; and at least one memory, the at least one memory being coupled to the at least one processing unit and storing instructions for execution by the at least one processing unit. The instructions, when executed by the at least one processing unit, causes the device to execute the method of the first aspect.

In a fourth aspect of the present disclosure, a computer-readable storage medium is provided. The medium has a computer program stored thereon, the program, when executed by a processor, implementing the method of the first aspect.

It should be understood that the content described in the summary is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIGS. 1A-1C show schematic diagrams of a traditional payment process;

FIG. 2 illustrates a schematic diagram of an example environment in which embodiments of the present disclosure may be implemented;

FIG. 3 illustrates a schematic diagram of a state change of a task according to some embodiments of the present disclosure;

FIG. 4 shows a schematic diagram of a processing process of a producer module according to some embodiments of the present disclosure;

FIG. 5 shows a schematic diagram of a processing process of a consumer module according to some embodiments of the present disclosure;

FIG. 6 illustrates an example block diagram of an order processing system according to some embodiments of the present disclosure;

FIG. 7 illustrates a flowchart of an example process of processing an order according to some embodiments of the present disclosure;

FIG. 8 illustrates a block diagram of an apparatus for processing an order according to some embodiments of the present disclosure; and

FIG. 9 illustrates a block diagram of a device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments described herein, conversely, these embodiments are provided for a more thorough and complete understanding of the present disclosure. It should be understood that the drawings and embodiments of the present disclosure are for exemplary purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

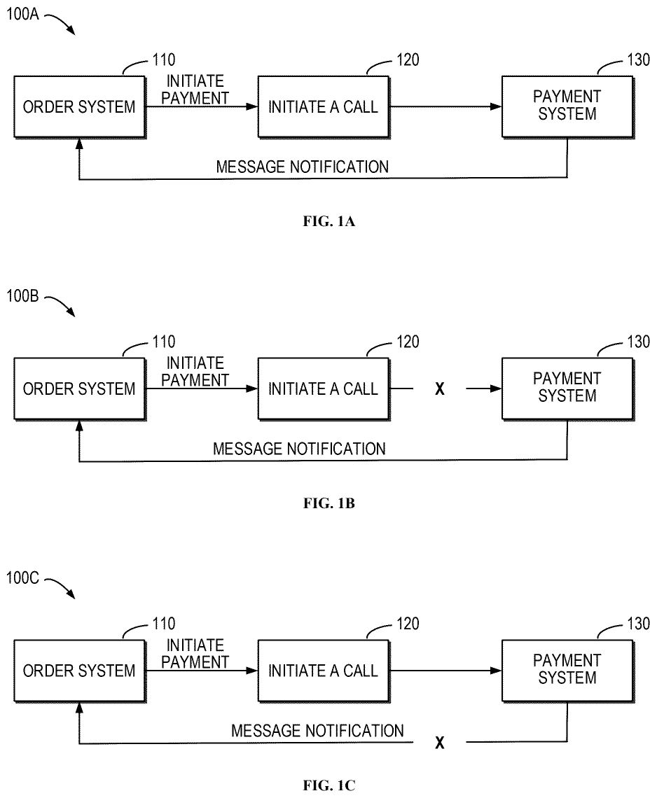

During a regular transaction process, as shown in FIG. 1A, it is usually the order system 110 that initiates payment and initiates an interface call 120. Correspondingly, the payment system 130 may return a message notification to the order system 110 to indicate the processing state of the order, for example, the order has been processed successfully, has failed to be processed, or is being processed.

However, in some cases, situations such as network timeout or network disconnection may occur when the order system 110 calls the payment interface. As shown in FIG. 1B, for example, the interface call 120 may not be sent to the payment system 130. However, in this case, the corresponding order has already been generated in the order system 110, but there may be no such order in the payment system 130. In this case, the call should be re-initiated.

In other cases, as shown in FIG. 1C, network timeout or disconnection may occur when the payment system 130 synchronously returns to the order system 110. In this case, corresponding orders have already been generated in both the order system 110 and the payment system 130. However, due to the network connection problem when the payment system 130 synchronously returns, the payment system cannot sense whether the order has been successful. At this time, a mechanism is required to reconfirm the order state to ensure that the order reaches its final state.

Therefore, for the order system, order compensation is an important task. Order compensation means compensating for the orders in an intermediate state until they reach the final state (success or failure). The timeliness and effectiveness of order compensation are the key factors affecting the user experience.

The embodiments of the present disclosure provide a solution for processing an order. In this solution, a group of uncompleted orders associated with a target time window may be determined. Further, the business party associated with this group of orders may be requested to execute these orders.

If a message indicating the completion of a group of orders is received from the business party, the order database maintained by the business party may be further queried to verify whether the group of orders have been completed. If the group of orders are verified as completed, the state of this group of orders may be updated to indicate that the orders are completed.

Based on this approach, on the one hand, the embodiments of the present disclosure may perform order compensation based on the time window method, thus improving the efficiency of order compensation. On the other hand, through the double-verification mechanism, the embodiments of the present disclosure may also improve the effectiveness of order compensation.

The following will describe the example solutions according to the embodiments of the present disclosure in detail with reference to the accompanying drawings.

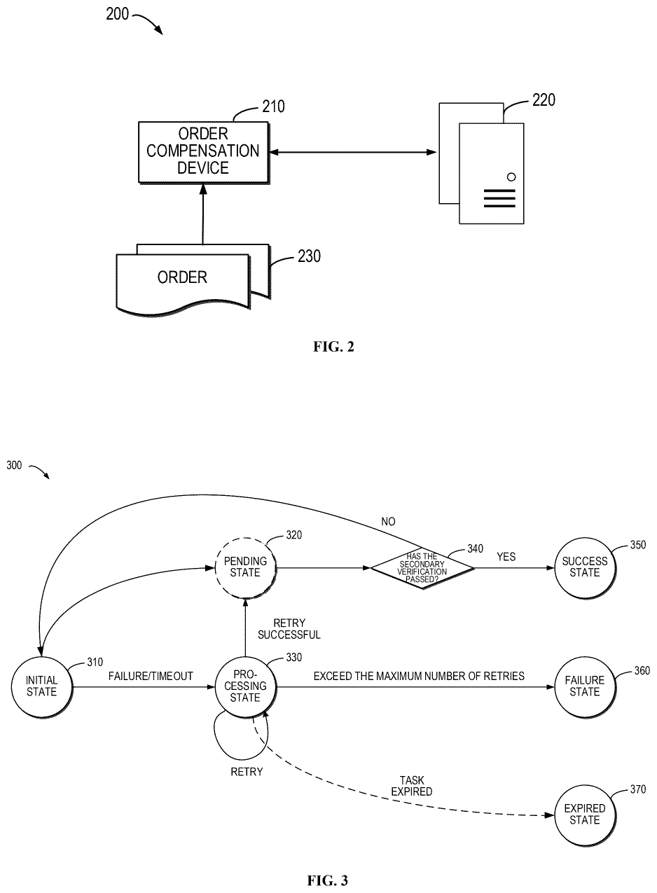

FIG. 2 shows a schematic diagram of an example environment 200 according to some embodiments of the present disclosure. As shown in FIG. 2, the environment 200 includes an order compensation device 210, which may be configured to communicate with a business party 220 to perform compensation operations (also known as, order compensation operations) for orders 230.

In some embodiments, such an order compensation device 210 may include any suitable electronic device managed by an order compensator (for example, an order compensation center). Such an order compensation device 210 may, for example, obtain orders 230 through an order database and use the interfaces provided by the business party 220 to push the orders 230 to be executed to the final state.

The specific processing process of the order compensation device 210 will be described in detail below with reference to the accompanying drawings.

### Example State Machine

In some embodiments, the order compensation device 210 may manage the compensation of orders 230 through a state machine. FIG. 3 shows a schematic diagram 300 of the state change of tasks according to some embodiments of the present disclosure.

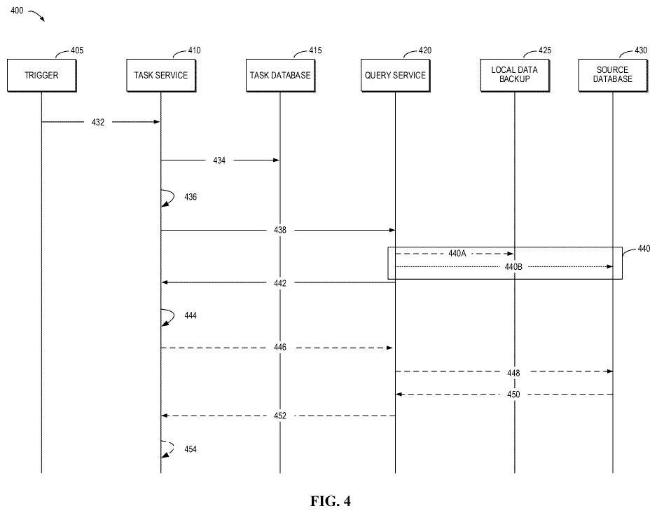

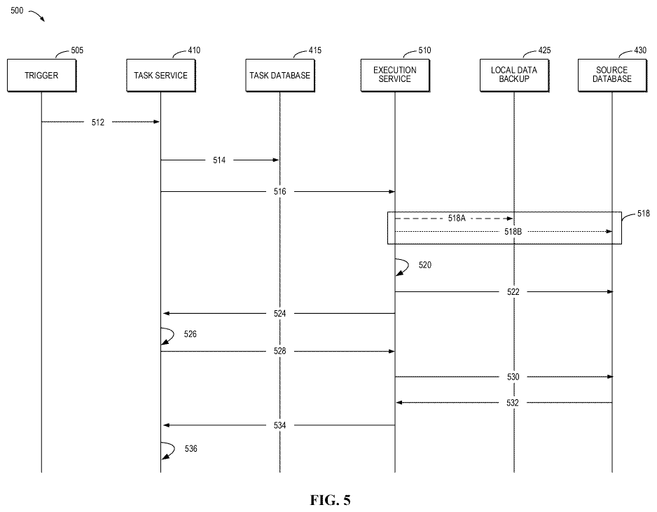

In some embodiments, the order compensation device 210 may obtain a group of uncompleted (i.e., not in the final state) orders associated with a predetermined time window. The determination process of this group of orders will be described in detail below with reference to FIG. 4.

Correspondingly, the order compensation device 210 may generate tasks corresponding to this group of orders. Such tasks may be set to an initial state 310, for example.

Further, the order compensation device 210 may use the execution interface (or service) provided by the business party 220 to request that this group of orders be executed. Correspondingly, if the order compensation device 210 determines from the business party 220 that this group of orders has been successfully executed (i.e., has reached the final state), the task may progress to a pending state 320.

Conversely, if the task execution fails or the task execution times out, the task may progress to a processing state 330. Correspondingly, in the processing state 330, the order compensation device 210 may perform a re-execution of the task. For example, the order compensation device 210 may use the execution interface (or service) provided by the business party 220 to re-request that this group of orders be executed.

If re-executing the task causes this group of orders to reach the final state, the task may similarly progress to the pending state. Conversely, if the task execution fails or times out, the order compensation device 210 may execute the task again.

In some embodiments, the order compensation device 210 may perform the re-execution or re-execution again of the task according to a fixed time interval. For example, the order compensation device 210 may re-execute the task after a fixed time interval since the last execution.

In some embodiments, the order compensation device 210 may also determine the time interval for the re-request according to the number of times the task has been re-executed. Specifically, the order compensation device 210 may determine the number of times the task has been re-executed and determine the time interval based on this number so that the time interval is positively correlated with the number. For example, if the task has been re-executed twice, the interval from the time of its third re-execution to the time of its second re-execution may be greater than the interval from the time of its second re-execution to the time of its first re-execution. In this way, the embodiments of the present disclosure may reduce the load pressure on the business party's interface.

Further, the order compensation device 210 may determine a target time based on the determined time interval for the re-request and both the historical time of the last task re-execution and the determined time interval. Additionally, the order compensation device 210 may execute the task at the determined target time to re-request the business party to execute the orders associated with the task.

In some embodiments, if the number of times a task has been re-executed has exceeded a threshold number or the task has expired, the order compensation device 210 may mark the task as unsuccessful. Specifically, if it is because the maximum number of retries (i.e., the threshold number) has been exceeded, the order compensation device 210 may mark the task as a failure state 360. Alternatively, if it is because the task has expired, the order compensation device 210 may mark the task as an expired state 370.

Continuing to refer to FIG. 3, as discussed above, if the business party feeds back that all the orders in the group have been completed, the task may progress to the pending state 320. Further, the order compensation device 210 may perform a secondary verification at block 340. Specifically, the order compensation device 210 may query the order database maintained by the business party 220 to verify whether the group of orders has been completed.

If the secondary verification fails, that is, there are still orders marked as uncompleted in the order database, the task will be reset to the initial state 310, and the state machine operation process shown in FIG. 3 will be re-executed. In some embodiments, when the secondary verification fails, the order compensation device 210 may also generate an alarm message, for example, to indicate that the order database of the business party does not match the state returned by the business party's interface.

Conversely, if the secondary verification passes, the order compensation device 210 may set the task to the success state 350 to indicate that the at least one uncompleted order has been successfully pushed to the completed state, that is, the order compensation operation has been completed.

Based on the state machine switching process introduced above, the embodiments of the present disclosure may effectively manage the order compensation process through the way of task state conversion, thus improving the reliability of order compensation.

In some embodiments, the order compensation device 210 may also maintain execution information corresponding to the task, also known as a flow table. For example, the order compensation device 210 may maintain execution information associated with the re-execution of the task.

Such execution information may include, for example, information of a group of orders associated with the task, such as the order identifier. Alternatively, or additionally, such execution information may also include execution description information about each re-execution, for example, the time of re-execution, the result of re-execution (for example, the number of orders successfully pushed to the final state, the number of orders not successfully pushed to the final state), etc. Alternatively, or in addition, such execution information may also include reason description information for task execution failure or execution timeout, for example, the reason why the orders returned by the business party were not successfully pushed to the final state.

By maintaining such execution information, the embodiments of the present disclosure may enable the order compensator to explicitly manage the order compensation process. Additionally, the order compensation device 210 may also provide such execution information, for example, for analyzing the task.

### Example Producer Module

In some embodiments, the order compensation device 210 may use a producer module and a consumer module to manage the generation, circulation, and consumption of tasks.

FIG. 4 shows a schematic diagram of the processing process 400 of the producer module according to some embodiments of the present disclosure. As shown in FIG. 4, the producer module may include a trigger 405, a task service 410, a task database 415. The query service 420, the local data backup 425, and the source database 430 may be provided by the business party, for example.

In some embodiments, the local data backup 425, also known as an order data copy, may be, for example, a data mirror of the source database 430 constructed in a heterogeneous manner. It may be deployed locally at the order compensator to improve access efficiency and reduce the database access pressure on the business party.

As shown in FIG. 4, at 432, the trigger 405 (also known as the task trigger 405) may be configured to periodically trigger the task service 410 to generate tasks. Correspondingly, at 434, the task service 410 may query the task database 415 and, at 436, determine the task identifier to be assigned to the task.

Further, at 438, the task service 410 may call the query service 420 provided by the business party. At 440, the query service 420 may determine a group of uncompleted orders associated with the time window corresponding to the task.

In some embodiments, at 440A, the query service 420 may use the local data backup 425 to query the state of orders to determine a group of uncompleted orders.

Alternatively, at 440B, the query service 420 may also use the source database 430 (i.e., the order database) of the business party to query the state of orders to determine a group of uncompleted orders. It should be understood that since the local data backup 425 is a heterogeneous mirror of the source database 430, its data timeliness is usually weaker than that of the source database 430. However, thanks to the fact that such a local data backup 425 may be deployed locally at the order compensator, this may effectively reduce the database access pressure on the business party.

Further, the query service 420 may return the query result to the task service 410. For example, the query service 420 may return a query result indicating that all orders within the time window have been completely executed. Or the query service 420 may also return a query result indicating a group of uncompleted orders within the time window.

Further, at 444, the task service 410 may perform actions according to the order state information. Specifically, if the query service 420 returns a query result indicating that all orders within the time window have been completed according to the source database 430, the task service 410 may not create the task.

Alternatively, if the query service 420 returns a query result indicating a group of uncompleted orders according to the local data backup 425 or the source database 430, the task service 410 may create a task corresponding to the group of orders according to the query result.

Alternatively, if the query service 420 returns a query result indicating that all orders within the time window have been completed according to the local data backup 425, the task service 410 may continue to execute the process from 446 to 454 shown in FIG. 4.

Specifically, at 446, the task service 410 may send a request for secondary verification to the query service 420. Further, the query service 420 may query the source database 430 to verify whether all orders within the time window have been completed.

At 450, the source database 430 may return the verification result, and at 452, the query service returns the verification result to the task service 410. Further, at 454, the task service 410 may perform corresponding actions according to the verification result. Specifically, if the verification result indicates that all orders within the time window have been completely executed, the task service 410 may not create a task. Conversely, if the verification result indicates that a group of orders within the time window have not been completely executed, the task service 410 may create a task for the group of orders.

Based on the secondary verification process during the task creation stage, the embodiments of the present disclosure may improve the reliability of task creation.

In some embodiments, the producer module may also perform a completeness check of tasks, for example.

Specifically, the producer module may obtain the consumption state of a group of historical tasks associated with a historical time window, where the length of the historical time window is greater than the target time window for normally generating tasks. For example, the producer module may check the task sequence within the past 48 hours and determine whether there are tasks that have not been consumed (or are missing).

Exemplarily, the producer module may check whether the task sequence is complete according to the identifier continuity of tasks or the continuity of the time windows corresponding to tasks to determine the target historical task that has not been consumed.

Further, the producer module may use a process similar to task creation (for example, refer to 440 in FIG. 4) to determine whether the orders within the historical event window corresponding to the task have been completed. In the case of uncompleted orders, the producer module may create a new task corresponding to the group of uncompleted orders and provide it to the consumer module for execution.

In this way, the embodiments of the present disclosure may further improve the completeness of the task list and avoid the occurrence of missing tasks.

### Example Consumer Module

The following will describe an exemplary processing process of the consumer module with reference to FIG. 5. FIG. 5 shows a schematic diagram of the processing process 500 of the consumer module according to some embodiments of the present disclosure.

As shown in FIG. 5, the consumer module may include the task service 410 and the task database 415 introduced above. In addition, unlike the producer module, the consumer module uses the execution service 510 provided by the business party instead of the query service 420.

Specifically, as shown in FIG. 5, at 512, the trigger 505 (also known as the execution trigger 505, which may be the same as or different from the task trigger 405) may trigger the task service 410. At 514, the task service 410 may query the task database 415 to record one or more tasks that have not been successfully executed within a certain period of time.

For the convenience of description, the following will take a single task as an example to introduce the execution of the consumer module. Further, at 516, the task service 410 may call the execution service 510 provided by the business party to promote the execution of a group of uncompleted orders corresponding to the task.

At 518, the execution service 510 may obtain detailed information of the group of orders. Specifically, the task service may obtain the order detailed information from the local data backup 425 at 518A. Alternatively, the execution service 510 may also obtain the order detailed information from the source database 430.

Further, at 520, the execution service 510 may call the downstream interface provided by the business party and promote the execution of the orders according to the order detailed information. At 522, if there is an update to the order state, the execution service 522 may update the source database 430. Alternatively, such update information may also be synchronized to the local data backup 425 according to the preset synchronization logic.

At 524, the execution service 510 may return the task execution result to the task service 410. At 526, the task service 410 may perform corresponding actions according to the execution result and with reference to the state machine shown in FIG. 3.

Exemplarily, if the execution result indicates that not all of the orders corresponding to the task have been pushed to the final state, the task service 410 may, for example, control the re-execution of the task according to the state machine shown in FIG. 3 until the task reaches the success state 350, the failure state 360, or the expired state 370.

In some embodiments, if the indication result indicates that all the orders in the group corresponding to the task have been pushed to the final state, at 528, the task service 410 may call the execution service 510 to perform secondary verification.

At 530, the execution service 510 may query the source database 430 to verify whether all the orders corresponding to the task have been completely executed. At 532, the source database 430 may return the verification result to the execution service 510.

Further, the execution service 510 may send the verification result to the task service 410. At 536, the task service 410 may perform corresponding actions according to the verification result. Specifically, if the verification result indicates that all orders have been completely executed, the task service 410 may mark the task as the success state 350.

Conversely, if the verification result indicates that there are orders that have not been completely executed, the task service 410 may reset the task to the initial state 310, so as to re-execute the task. Additionally, the task service 410 may also generate an alarm message, for example, to indicate that the source database 430 of the business party does not match the state returned by the execution service 510.

Based on the task consumption process discussed above, the embodiments of the present disclosure may effectively control the order compensation process through the consumer module and improve the efficiency and reliability of order compensation.

### Example Order Compensation System

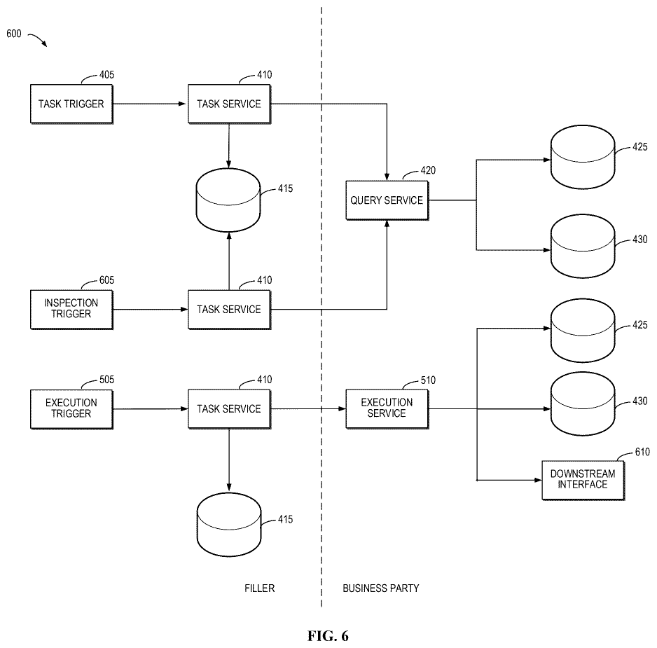

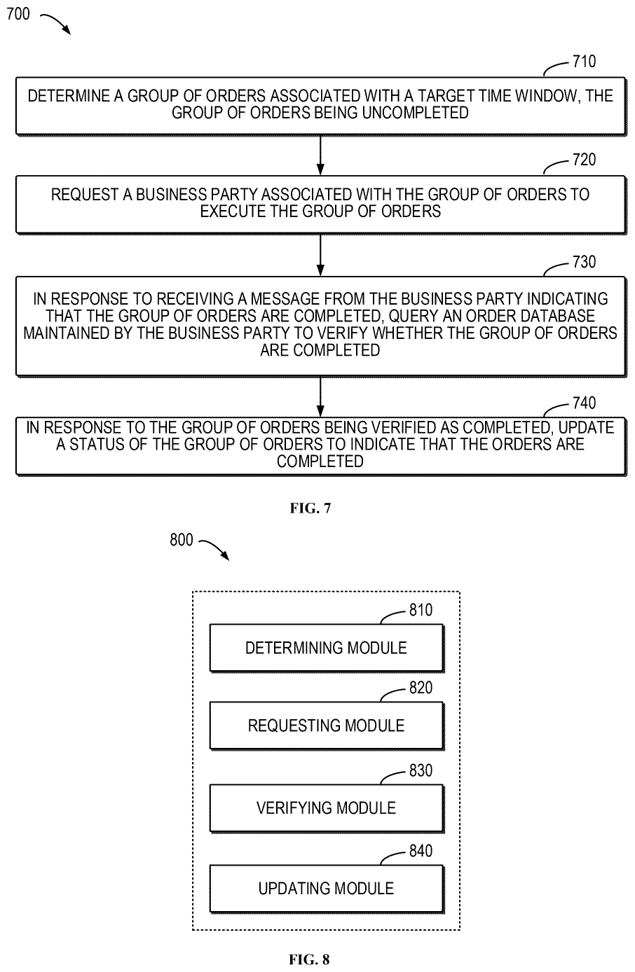

FIG. 6 further shows a block diagram of an example order compensation system 600 according to some embodiments of the present disclosure. As shown in FIG. 6, the order compensation system 600 may include different modules or components corresponding to the order compensator and the business party.

In some embodiments, for the order compensator, the order compensation system 600 may include multiple triggers, such as task trigger 405, execution trigger 505, and inspection trigger 605. The task trigger 405 may be configured to periodically trigger the generation of tasks, the execution trigger 505 may be configured to periodically trigger the consumption of tasks, and the inspection trigger 605 may be configured to periodically trigger the inspection of task completeness.

In some embodiments, such triggers may be designed to only handle the logic of task triggering and do not perform additional task logic by themselves. Additionally, no cache is used within these triggers. Thus, a lightweight design of the triggers may be achieved, ensuring the stability and execution efficiency of the triggers.

In some embodiments, preferred Functions as a Service (FAAS) may be used to implement the triggers. Alternatively, Cronjob may also be used as a disaster recovery trigger, further improving the stability of the system.

Further, as shown in FIG. 6, the task service 410 may perform task creation upon being triggered by the task trigger 405, perform task completeness inspection upon being triggered by the inspection trigger 605, and perform task consumption upon being triggered by the execution trigger 505. Correspondingly, such a task service 410 may only rely on the local task database 415.

Additionally, for task creation and task completeness inspection, the task service 410 may also call the query service 420 provided by the business party to determine uncompleted orders based on the local database 425 or the source database 430.

For task consumption, the task service 410 may call the execution service 510 provided by the business party to query order information using the local database 425 or the source database 430, call the downstream interface 610 to facilitate order execution, and/or update the order state in the source database 430.

In this way, the embodiments of the present disclosure may reduce the dependence of the order compensation process on the business party. For example, it may only provide two interfaces: a query interface and an execution interface. Thus, the flexibility of the order compensation system may be improved, providing support for the involvement of different business parties.

### Example Processes

FIG. 7 illustrates a flowchart of an example process 700 for processing an order according to some embodiments of the present disclosure. Process 700 may be performed by order compensation device 210 shown in FIG. 1, process 700 described below with reference to FIG. 1.

As shown in FIG. 7, at block 710, the order compensation device 210 determines a group of orders associated with a target time window, the group of orders being uncompleted.

At block 720, the order compensation device 210 requests a business party associated with the group of orders to execute the group of orders.

At block 730, in response to receiving a message from the business party indicating that the group of orders are completed, the order compensation device 210 queries an order database maintained by the business party to verify whether the group of orders are completed.

At block 740, in response to the group of orders being verified as completed, the order compensation device 210 updates a state of the group of orders to indicate that the orders are completed.

In some embodiments, determining the group of orders associated with the target time window includes: determining the target time window based on a predetermined time period; and obtaining the group of orders associated with the target time window.

In some embodiments, determining a group of orders associated with a target time window includes: querying order data maintained by the business party to determine a first query result indicating whether the group of orders are completed; and determining the group of orders that are uncompleted based on the first query result.

In some embodiments, determining the group of orders associated with the target time window includes: querying a copy of order data corresponding to the order database deployed locally at a order compensator to determine a second query result indicating whether the group of orders are completed; and determining the group of orders that are uncompleted based on the second query result.

In some embodiments, determining the group of orders that are uncompleted from the group of orders based on the second query result include: in response to the second query result indicating that the group of orders are all completed, querying the order data maintained by the business party to determine a third query result indicating whether the group of orders are completed; and determining the group of orders that are uncompleted based on the third query result.

In some embodiments, requesting the business party associated with the group of orders to execute the group of orders includes: generating, by a producer module, a first task associated with the group of orders; and requesting, by a consumer module, the business party to execute the group of orders according to the first task.

In some embodiments, the group of orders is a first group of orders, and the method further includes: obtaining, by the producer module, a consumption state of a group of historical tasks associated with a historical time window, a length of the historical time window being greater than that of the target time window; and determining, by the producer module, a target historical task that is unconsumed from the group of historical tasks; determining, by the producer module, a second group of orders associated with the target historical task, the second group of orders being uncompleted; and generating, by the producer module, a second task associated with the second group of orders, causing the consumer module to request the business party to execute the second group of orders according to the second task.

In some embodiments, the process 700 further includes: generating a task associated with the group of orders; iteratively performing the following at least once: in response to determining that execution of the task fails or has timed out, re-executing the task to re-request the business party to execute the group of orders; and in response to a number of times the task is re-executed exceeding a threshold number or the task having expired, marking the task as unsuccessful.

In some embodiments, t re-executing the task includes: determining a time interval for re-execution; in response to requesting the re-execution of the task being not the first occurrence, determining a target instant according to a historical instant of a last re-execution and the time interval; and re-executing the task at the target instant.

In some embodiments, determining a time interval for re-requesting includes: determining a number of times that the task has been re-executed; and determining the time interval based on the number of times, causing the time interval to be positively correlated with the number of times.

In some embodiments, the process 700 further includes maintaining execution information associated with the re-execution of the task, the execution information indicating at least one of the following: order information of the group of orders, execution description information about re-execution, reason description information about execution failure or execution timeout of the task.

In some embodiments, the process 700 further includes providing the execution information for analyzing the task.

In some embodiments, the process 700 further includes: in response to the group of orders being verified as uncompleted, re-requesting the business party to execute the group of orders.

In some embodiments, the business party provides a query interface for querying the order database, and an execution interface for requesting orders to be executed.

### Example Apparatus and Apparatus

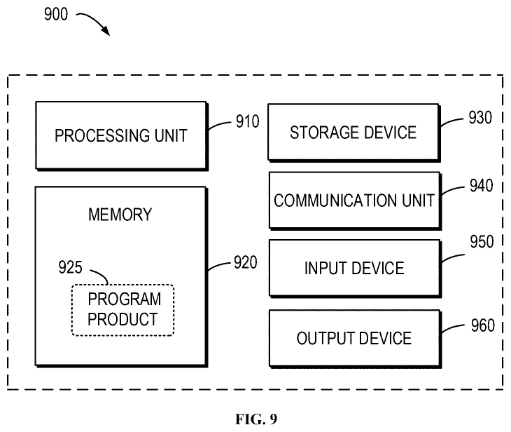

Embodiments of the present disclosure also provide a corresponding apparatus for implementing the above method or process. FIG. 8 is a schematic structural block diagram of an apparatus 800 for processing an order according to some embodiments of the present disclosure.

As shown in FIG. 8, the apparatus 800 includes a determining module 801 configured to determine a group of orders associated with a target time window, the group of orders being uncompleted.

The apparatus 800 further includes a requesting module 820 configured to request a business party associated with the group of orders to execute the group of orders.

The apparatus 800 further includes a verifying module 830 configured to, in response to receiving a message from the business party indicating that the group of orders are completed, query an order database maintained by the business party to verify whether the group of orders are completed.

In addition, the apparatus 800 further includes an updating module 840 configured to, in response to the group of orders being verified as completed, update a state of the group of orders to indicate that the orders are completed.

In some embodiments, the determining module 810 is further configured to: determine the target time window based on a predetermined time period; and obtain the group of orders associated with the target time window.

In some embodiments, the determining module 810 is further configured to: query order data maintained by the business party to determine a first query result indicating whether the group of orders are completed; and determine the group of orders that are uncompleted based on the first query result.

In some embodiments, the determining module 810 is further configured to: query a copy of order data corresponding to the order database deployed locally at an order compensator to determine a second query result indicating whether the group of orders are completed; and determine the group of orders that are uncompleted based on the second query result.

In some embodiments, the determining module 810 is further configured to: in response to the second query result indicating that the group of orders are all completed, query the order data maintained by the business party to determine a third query result indicating whether the group of orders are completed; and determine the group of orders that are uncompleted based on the third query result.

In some embodiments, the request module 820 is further configured to: generate, by a producer module, a first task associated with the group of orders; and request, by a consumer module, the business party to execute the group of orders according to the first task.

In some embodiments, the group of orders is a first group of orders, and the request module 820 is further configured to: obtain, by the producer module, a consumption state of a group of historical tasks associated with a historical time window, a length of the historical time window being greater than that of the target time window; determine, by the producer module, a target historical task that is unconsumed from the group of historical tasks; determine, by the producer module, a second group of orders associated with the target historical task, the second group of orders being uncompleted; and generate, by the producer module, a second task associated with the second group of orders, causing the consumer module to request the business party to execute the second group of orders according to the second task.

In some embodiments, the request module 820 is further configured to: generate a task associated with the group of orders; iteratively perform the following at least once: in response to determining that execution of the task fails or has timed out, re-executing the task to re-request the business party to execute the group of orders; and in response to a number of times the task is re-executed exceeding a threshold number or the task having expired, mark the task as unsuccessful.

In some embodiments, the request module 820 is further configured to: determine a time interval for re-execution; in response to requesting the re-execution of the task being not the first occurrence, determine a target instant according to a historical instant of a last re-execution and the time interval; and re-execute the task at the target instant.

In some embodiments, the request module 820 is further configured to: determine a number of times that the task has been re-executed; and determine the time interval based on the number of times, causing the time interval to be positively correlated with the number of times.

In some embodiments, the apparatus 800 is further configured to maintain execution information associated with the re-execution of the task, the execution information indicating at least one of the following: order information of the group of orders, execution description information about re-execution, reason description information about execution failure or execution timeout of the task.

In some embodiments, the apparatus 800 is further configured to provide the execution information for analyzing the task.

In some embodiments, the request module 820 is further configured to: in response to the group of orders being verified as uncompleted, re-request the business party to execute the group of orders.

In some embodiments, the business party provides a query interface for querying the order database, and an execution interface for requesting orders to be executed.

The units included in device 800 may be realized in various ways, including software, hardware, firmware, or any combination of them. In some embodiments, one or more units may be implemented using software and/or firmware, such as machine-executable instructions stored on a storage medium. Besides or as an alternative to machine-executable instructions, some or all of the units in device 800 may be at least partially implemented by one or more hardware logic components. By way of example and not limitation, exemplary types of hardware logic components that may be used include Field Programmable Gate Arrays (FPGA), Application Specific Integrated Circuits (ASIC), Application Specific Standard Products (ASSP), System on a Chip (SOC), Complex Programmable Logic Devices (CPLD), and so on.

FIG. 9 shows a block diagram of a computing device/server 900 in which one or more embodiments of the present disclosure may be implemented. It should be understood that the computing device/server 900 shown in FIG. 9 is only exemplary and should not impose any limitations on the functions and scope of the embodiments described in this article.

As shown in FIG. 9, the computing device/server 900 is in the form of a general-purpose computing device. Components of the computing device/server 900 may include, but are not limited to, one or more processors or processing units 910, a memory 920, a storage device 930, one or more communication units 940, one or more input devices 960, and one or more output devices 960. The processing unit 910 may be a physical or virtual processor and is capable of performing various processes according to the programs stored in the memory 920. In a multi-processor system, multiple processing units execute computer-executable instructions in parallel to enhance the parallel processing capabilities of the computing device/server 900.

The computing device/server 900 usually contains multiple computer storage media. Such media may be any accessible media that the computing device/server 900 may reach, including but not limited to volatile and non-volatile media, removable and non-removable media. The memory 920 may be volatile memory (such as registers, caches, Random Access Memory (RAM)), non-volatile memory (such as Read Only Memory (ROM), Electrically Erasable Programmable Read Only Memory (EEPROM), flash memory), or a certain combination of them. The storage device 930 may be a removable or non-removable medium and may include machine-readable media, such as a flash drive, a disk, or any other medium that may be used to store information and/or data (such as training data for training) and may be accessed within the computing device/server 900.

The computing device/server 900 may further include additional removable/non-removable, volatile/non-volatile storage media. Although not shown in FIG. 9, a disk drive for reading from or writing to a removable, non-volatile disk (e.g., “floppy disk”) and an optical disk drive for reading from or writing to a removable, non-volatile optical disk may be provided. In these cases, each drive may be connected to a bus (not shown) via one or more data media interfaces. The memory 920 may include a computer program product 925 with one or more program modules configured to execute various methods or actions of different embodiments of the present disclosure.

The communication unit 940 enables communication with other computing devices through a communication medium. Additionally, the functions of the components of the computing device/server 900 may be achieved by a single computing cluster or multiple computing machines that may communicate via communication connections. Thus, the computing device/server 900 may operate in a networked environment using logical connections with one or more other servers, network personal computers (PCs), or other network nodes.

The input device 950 may be one or more input devices, like a mouse, a keyboard, a trackball, etc. The output device 960 may be one or more output devices, such as a display, a speaker, a printer, etc. The computing device/server 900 may also communicate, as required, with one or more external devices (not shown) through the communication unit 940. These external devices may be storage devices, display devices, etc., devices that enable user interaction with the computing device/server 900, or any devices (such as network cards, modems, etc.) that enable the computing device/server 900 to communicate with one or more other computing devices. Such communication may be carried out via an input/output (I/O) interface (not shown).

According to an exemplary implementation of the present disclosure, a computer-readable storage medium is provided, on which one or more computer instructions are stored. One or more of these computer instructions are executed by a processor to implement the method described above.

Various aspects of the present disclosure are described here with reference to the flowcharts and/or block diagrams of methods, devices (systems), and computer program products implemented according to the present disclosure. It should be understood that each box in the flowcharts and/or block diagrams, as well as combinations of the boxes in the flowcharts and/or block diagrams, may be implemented by computer-readable program instructions.

These computer-readable program instructions may be provided to the processing unit of a general-purpose computer, a special-purpose computer, or other programmable data processing device, thus producing a machine. When these instructions are executed by the processing unit of the computer or other programmable data processing device, a device that realizes the functions/actions specified in one or more boxes of the flowcharts and/or block diagrams is produced. These computer-readable program instructions may also be stored in a computer-readable storage medium. These instructions make the computer, the programmable data processing device, and/or other devices work in a specific way. Thus, the computer-readable medium storing the instructions includes an article of manufacture that contains instructions for realizing various aspects of the functions/actions specified in one or more boxes of the flowcharts and/or block diagrams.

Computer-readable program instructions may also be loaded onto a computer, other programmable data processing device, or other device, causing a series of operational steps to be executed on the computer, other programmable data processing device, or other device to generate a computer-implemented process. In this way, the instructions executed on the computer, other programmable data processing device, or other device may implement the functions/actions specified in one or more boxes of the flowcharts and/or block diagrams.

The flowcharts and block diagrams in the accompanying drawings show the possible implementation architectures, functions, and operations of systems, methods, and computer program products according to multiple implementations of the present disclosure. In this regard, each box in the flowchart or block diagram may represent a module, a program segment, or a part of an instruction. The part of the module, program segment, or instruction contains one or more executable instructions for realizing the specified logical function. In some alternative implementations, the functions marked in the boxes may also occur in an order different from that marked in the accompanying drawings. For example, two consecutive boxes may actually be executed almost in parallel, and sometimes they may be executed in the opposite order, depending on the functions involved. It should also be noted that each box in the block diagram and/or flowchart, as well as combinations of boxes in the block diagram and/or flowchart, may be implemented by a dedicated hardware-based system that performs the specified functions or actions, or may be implemented by a combination of dedicated hardware and computer instructions.

The various implementations of the present disclosure have been described above. The above description is exemplary, not exhaustive, and is not limited to the disclosed implementations. For ordinary technicians in this technical field, many modifications and changes will be obvious without departing from the scope and spirit of the described implementations. The choice of terms used in this article aims to best explain the principles of the implementations, their practical applications, or improvements to the technology in the market, or to enable other ordinary technicians in the field to understand the disclosed implementations.

1. A method for processing an order, comprising:
determining a group of orders associated with a target time window, the group of orders being uncompleted;
requesting a business party associated with the group of orders to execute the group of orders;
in response to receiving a message from the business party indicating that the group of orders are completed, querying an order database maintained by the business party to verify whether the group of orders are completed; and
in response to the group of orders being verified as completed, updating a state of the group of orders to indicate that the orders are completed.

2. The method of claim 1, wherein determining the group of orders associated with the target time window comprises:
determining the target time window based on a predetermined time period; and
obtaining the group of orders associated with the target time window.

3. The method of claim 1, wherein determining a group of orders associated with a target time window comprises:
querying order data maintained by the business party to determine a first query result indicating whether the group of orders are completed; and
determining the group of orders that are uncompleted based on the first query result.

4. The method of claim 1, wherein determining the group of orders associated with the target time window comprises:
querying a copy of order data corresponding to the order database deployed locally at an order compensator to determine a second query result indicating whether the group of orders are completed; and
determining the group of orders that are uncompleted based on the second query result.

5. The method of claim 4, wherein determining the group of orders that are uncompleted from the group of orders based on the second query result comprises:
in response to the second query result indicating that the group of orders are all completed, querying the order data maintained by the business party to determine a third query result indicating whether the group of orders are completed; and
determining the group of orders that are uncompleted based on the third query result.

6. The method of claim 1, wherein requesting the business party associated with the group of orders to execute the group of orders comprises:
generating, by a producer module, a first task associated with the group of orders; and
requesting, by a consumer module, the business party to execute the group of orders according to the first task.

7. The method of claim 6, wherein the group of orders is a first group of orders, and the method further comprises:
obtaining, by the producer module, a consumption state of a group of historical tasks associated with a historical time window, a length of the historical time window being greater than that of the target time window;
determining, by the producer module, a target historical task that is unconsumed from the group of historical tasks;
determining, by the producer module, a second group of orders associated with the target historical task, the second group of orders being uncompleted; and
generating, by the producer module, a second task associated with the second group of orders, causing the consumer module to request the business party to execute the second group of orders according to the second task.

8. The method of claim 1, further comprising:
generating a task associated with the group of orders;
iteratively performing the following at least once: in response to determining that execution of the task fails or has timed out, re-executing the task to re-request the business party to execute the group of orders; and
in response to a number of times the task is re-executed exceeding a threshold number or the task having expired, marking the task as unsuccessful.

9. The method of claim 8, wherein re-executing the task comprises:
determining a time interval for re-execution;
in response to requesting the re-execution of the task being not the first occurrence, determining a target instant according to a historical instant of a last re-execution and the time interval; and
re-executing the task at the target instant.

10. The method of claim 9, wherein determining the time interval for re-execution comprises:
determining a number of times that the task has been re-executed; and
determining the time interval based on the number of times, causing the time interval to be positively correlated with the number of times.

11. The method of claim 8, further comprising:
maintaining execution information associated with the re-execution of the task, the execution information indicating at least one of the following: order information of the group of orders, execution description information about re-execution, reason description information about execution failure or execution timeout of the task.

12. The method of claim 11, further comprising:
providing the execution information for analyzing the task.

13. The method of claim 1, further comprising:
in response to the group of orders being verified as uncompleted, re-requesting the business party to execute the group of orders.

14. The method of claim 1, wherein the business party provides a query interface for querying the order database, and an execution interface for requesting orders to be executed.

15-17. (canceled)

18. An electronic device, comprising:
at least one processor; and
at least one memory, the at least one memory being coupled to the at least one processor and storing instructions for execution by the at least one processor, the instructions, when executed by the at least one processor, causing the device to execute acts comprising:
determining a group of orders associated with a target time window, the group of orders being uncompleted;
requesting a business party associated with the group of orders to execute the group of orders;
in response to receiving a message from the business party indicating that the group of orders are completed, querying an order database maintained by the business party to verify whether the group of orders are completed; and
in response to the group of orders being verified as completed, updating a state of the group of orders to indicate that the orders are completed.

19. The electronic device of claim 18, wherein determining the group of orders associated with the target time window comprises:
determining the target time window based on a predetermined time period; and
obtaining the group of orders associated with the target time window.

20. The electronic device of claim 18, wherein determining a group of orders associated with a target time window comprises:
querying order data maintained by the business party to determine a first query result indicating whether the group of orders are completed; and
determining the group of orders that are uncompleted based on the first query result.

21. The electronic device of claim 18, wherein determining the group of orders associated with the target time window comprises:
querying a copy of order data corresponding to the order database deployed locally at a order compensator to determine a second query result indicating whether the group of orders are completed; and
determining the group of orders that are uncompleted based on the second query result.

22. The electronic device of claim 21, wherein determining the group of orders that are uncompleted from the group of orders based on the second query result comprises:
in response to the second query result indicating that the group of orders are all completed, querying the order data maintained by the business party to determine a third query result indicating whether the group of orders are completed; and
determining the group of orders that are uncompleted based on the third query result.

23. A non-transitory computer-readable storage medium, having a computer program stored thereon, the program, when executed by a processor, implementing acts comprising:
determining a group of orders associated with a target time window, the group of orders being uncompleted;
requesting a business party associated with the group of orders to execute the group of orders;
in response to receiving a message from the business party indicating that the group of orders are completed, querying an order database maintained by the business party to verify whether the group of orders are completed; and
in response to the group of orders being verified as completed, updating a state of the group of orders to indicate that the orders are completed.
